(19) United States
(12) Patent Application Publication
(10) Pub. No.: US 2013/0103991 A1
(43) Pub. Date: Apr. 25, 2013

(54) Method of Protecting a Configurable Memory Against Permanent and Transient Errors and Related Device

(71) Applicants: Samuel Evain, Gif sur Yvette (FR); Yannick Bonhomme, Breuillet (FR); Valentin Gherman, Massy (FR)

(72) Inventors: Samuel Evain, Gif sur Yvette (FR); Yannick Bonhomme, Breuillet (FR); Valentin Gherman, Massy (FR)

(21) Appl. No.: 13/805,291

(22) PCT Filed: Jun. 1, 2011
(86) PCT No.: PCT/EP11/59134

§ 371 Date: Dec. 18, 2012

(30) Foreign Application Priority Data
Jun. 18, 2010 (FR) 10 54841

(51) Int. Cl. G06F 11/10

(52) U.S. Cl. CPC G06F 11/10
USPC 714/701

(57) ABSTRACT

A method for protecting digital memory against permanent and transient errors and a related device, the digital data being stored in at least one storage matrix of memory cells in a given number of rows and columns, comprises: an encoding step generating code words from data organized in binary words by application of asymmetric code introducing at least two different levels of protection, the first level of protection said to be high being associated with a first sub-group of bits of the code word and a second level of protection said to be low being associated with a second sub-group of the same word; swapping positions of the bits of the code word making the bits with a high level of protection correspond for their storage to the columns of the storage area comprising defective memory cells and the bits with a low level of protection to the remaining columns.

One subject of the invention is a method for protecting a digital memory against permanent and transient errors and a related device. It is notably applicable to the fields of digital electronics and nanometric technologies. The invention can be used, for example, in data storage systems.

In a digital system, the data or information is usually recorded in a digital memory in the form of binary values called bits. Errors can occur in the stored data which may be transient or permanent, as discussed hereinafter. If these errors are not corrected or masked, they may lead to operating errors and eventually the failure of the system.

Transient errors are produced by interference with the environment or by the radioactivity produced by certain impurities in the material composing the digital memory.

As far as permanent errors are concerned, these result from hardware defects and represent an important problem, in particular in memory circuits fabricated using nanometric technology. Permanent errors are the consequence of defects in the physical structure of the circuits, these defects appearing during the production of the circuits and/or due to aging. A high density of hardware defects in a storage system results in a large number of permanent errors. These problems must be taken into account during the design of digital systems using memory circuits.

In order to guarantee an acceptable level of integrity for the stored data or in order to increase the production yield, some electronic systems use codes for error detection and correction, usually denoted by the acronym EDAC.

In digital systems implementing a protection of the EDAC type, the data are encoded during the writing of said data in the storage area or areas included in one or more memory circuits. When data is encoded with an EDAC code, check bits, also known as redundant bits, are added to binary data words in order to form code words. The check bits of an EDAC linear code are calculated by means of a parity-check matrix H. The latter are chosen in such a manner that the multiplication between the matrix H and the code word formed by the concatenation of the data bits with the check bits produce a null vector.

When the data present in the memory circuit or circuits is read, the code words are verified. For this purpose, a check vector, also referred to as syndrome vector, is calculated in order to detect and to correct potential errors appearing in the code words. If the syndrome vector corresponds to a null vector, the coded word is considered as correct. A non-null syndrome vector indicates the presence of at least one error. If the syndrome vector allows the positions of the affected bits to be identified, the code word is corrected, otherwise an uncorrectable error is flagged up.

Various EDAC codes may be implemented, these having different error detection and correction capacities. By way of example, Hamming coding allows a simple error to be corrected, in other words an error that affects a single bit. This capacity for correction is categorized as SEC, the acronym for “Single Error Correction”.

Another example of EDAC code is the extended Hamming code. An extended Hamming code is a Hamming code for which a parity bit is added to the whole of the bits of a code word, and this is to allow the detection of double errors, in other words of errors affecting two bits in a code word. The codes of this family are capable of correcting a single error and of detecting a double error. This capacity for correction is categorized as SEC-DED, the acronym for “Single Error Correction-Double Error Detection”. Another example of a code having a SEC-DED capacity is the Hsiao code.

SEC-DED codes allow both permanent and/or transient errors to be handled. However, usually, when these solutions are used for correcting permanent errors, they often lose their capacity to correct transient errors.

EDAC codes exist that allow the correction of single errors and also the correction of a selection of double errors, while at the same time having the capacity for detecting uncorrectable double errors. One example of such a code is described in the U.S. Pat. No. 3,755,779 entitled Error correction system for single-error correction, related-double-error correction and unrelated-double-error-detection. In this patent, the double errors that are able to be corrected must be composed of two adjacent bits. This type of double error usually corresponds to transient errors rather than to permanent errors. The correction for adjacent double errors does not allow all the possible combinations of errors to be covered in the case where permanent errors are involved.

The codes allowing the correction of all the multiple errors which affect at least two bits in a code word are very costly in terms of processing, performance, surface area and power consumption. It is therefore difficult in practice to systematically implement such a code for protecting the whole of an electronic memory.

Another technique consists in using spare columns, a technique denoted as ‘column replacement’. Indeed, a memory circuit is composed of at least one storage area, also known as a memory bank, a storage area usually corresponding to a storage matrix composed of memory cells organized in a given number of rows and columns. A stored bit is thus positioned within a memory cell localized at the intersection of a row and a column of the bank. The use of additional columns called replacement columns allows defective columns to be masked, in other words allows them to be replaced. One drawback inherent in this technique is that it does not allow transient errors to be handled, and only permanent errors can be processed.

Mixed approaches combining the use of techniques using EDAC codes with techniques using replacement columns have been devised. They allow a high density of permanent errors to be tolerated, as described notably in the article by C. H. Stapper and Hsing-San Lee entitled Synergistic Fault-Tolerance for Memory Chips, IEEE Trans. Computers 41(9), 1992, pages 1078-1087.

The simultaneous use of the replacement columns and of an EDAC code has a high cost in terms of surface area. It is therefore crucial to minimize the number of replacement columns whilst at the same time maintaining a high level of protection against permanent and transient errors.

In the majority of banks composing a memory circuit, the replacement of the entirely defective columns does not require the use of all the replacement columns. In this case, the replacement columns still available can be used for replacing memory columns comprising defective memory cells.

One aim of the invention is notably to overcome the aforementioned drawbacks.

One subject of the invention is a method for protecting digital data stored in at least one storage area, said area corresponding to a storage matrix composed of memory cells organized in a given number of rows and columns. Said method comprises an encoding step generating code words from data organized in binary words by application of an asymmetric code introducing at least two different levels of protection, the first level of protection said to be high being associated with a first sub-group of bits of the code word and a second level of protection said to be low being associated with a second sub-group of the same word; it also comprises a step for swapping the positions of the bits of the code word making the bits with a high level of protection correspond for their storage to the columns of the storage area comprising defective memory cells and the bits with a low level of protection to the remaining columns.

According to one aspect of the invention, the number of bits of a code word corresponds to the numbers of columns available in a storage area.

According to another aspect of the invention, the asymmetric code is chosen in such a manner as to introduce a protection on the last f bits of each code word by using a Hamming code, the sub-group composed of the other bits of said word not being protected.

The asymmetric code is, for example, an extended SEC-DED code with s additional check bits.

In one embodiment, the matrix of the asymmetric code is designed in such a manner that said code allows the correction of a single error over the whole of the code word, provides the correction for any given double error which affects at least one bit of a sub-set of f bits in the code word, this sub-set being that with which a high level of protection is associated and allows the detection of the other double errors over the whole of the word of the code.

Another subject of the invention is a method for reading digital data stored in a storage area and protected by implementing the method for protecting digital data previously described. This reading method comprises a step for the re-ordering of the bits of the stored code words in such a manner that the latter recover their initial order from before the position swap carried out when they are written into memory; and a step for decoding said re-ordered code words, this step carrying out a detection of errors in the code word together with an error correction, said detection and correction depending on the asymmetric code used in the encoding and also on its capacities for correction and for detection.

A further subject of the invention is a device for protecting digital data stored in at least one storage area, said area corresponding to a storage matrix composed of memory cells organized in a given number of rows and columns. The device comprises at least:
one encoding module generating code words from data organized in binary words by application of an asymmetric code introducing at least two different levels of protection, the first level of protection said to be high being associated with a first sub-group of bits of the code word and the second level of protection said to be low being associated with a second sub-group of the same word;
one module for swapping position of the bits of the code word making the bits with a high level of protection of said words correspond for their storage to the columns of the storage area comprising defective memory cells and the bits with a low level of protection to the remaining columns.

In one embodiment, the position swap of the bits carried out by the swapping module is controlled by using configuration data indicating the memory columns comprising defective memory cells of the storage area.

According to one aspect of the invention, the swapping module comprises multiplexers allowing the bits to be routed at the output of the encoding module toward the columns of the storage area, said multiplexer being controlled by control signals representative of the configuration data.

According to another aspect of the invention, the device comprises means for re-ordering the bits of the stored code words in such a manner that the latter recover their initial order from before the swap, and means for decoding the re-ordered code words while carrying out a detection of errors in the code word together with a correction of errors, said detection and correction depending on the asymmetric code used by the encoding module and also on its capacity for correction and for detection.

If an uncorrectable error is detected, an error signal is for example generated.

One notable advantage of the invention is to optimize the capacity for correction of the codes used for protecting the data stored in a digital memory while at the same time limiting the number of replacement columns. It is furthermore possible to reconfigure the memory circuit implementing the invention by taking into account the specific distribution of the defective memory cells, where this reconfiguration may be implemented during the production of the memory circuit and/or during its use.

Other features and advantages of the invention will become apparent with the aid of the description that follows, presented by way of non-limiting illustration and with regard to the appended drawings amongst which:

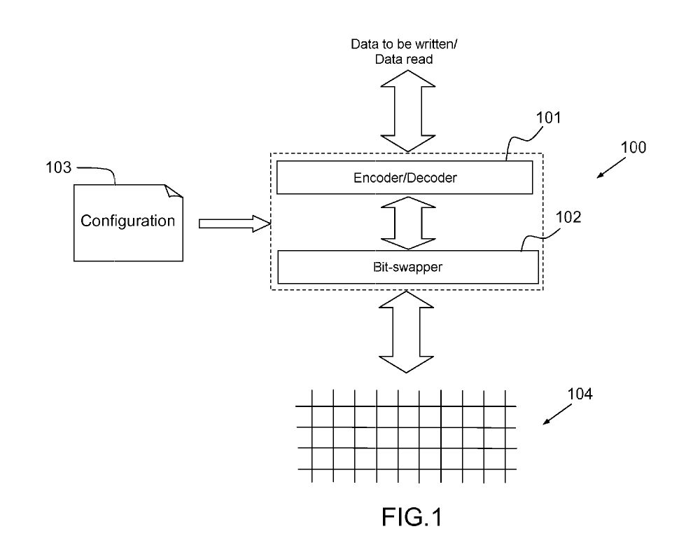

FIG. 1 illustrates the principle of a memory protection device according to the invention;

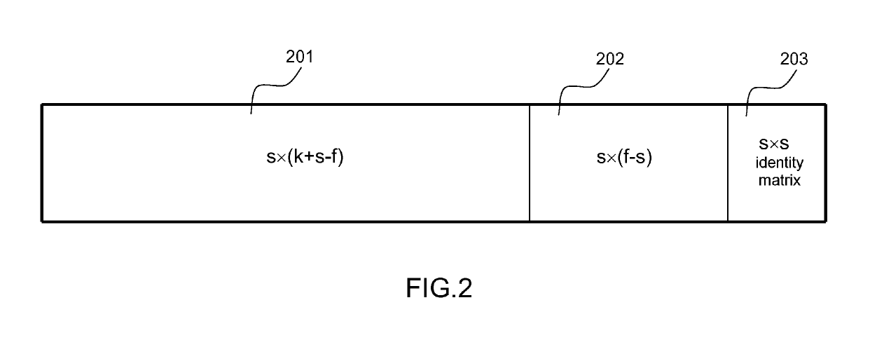

FIG. 2 presents one example of a parity-check matrix H allowing the implementation of an asymmetric A-EDAC code providing the correction of single errors affecting a sub-set off bits in the code words;

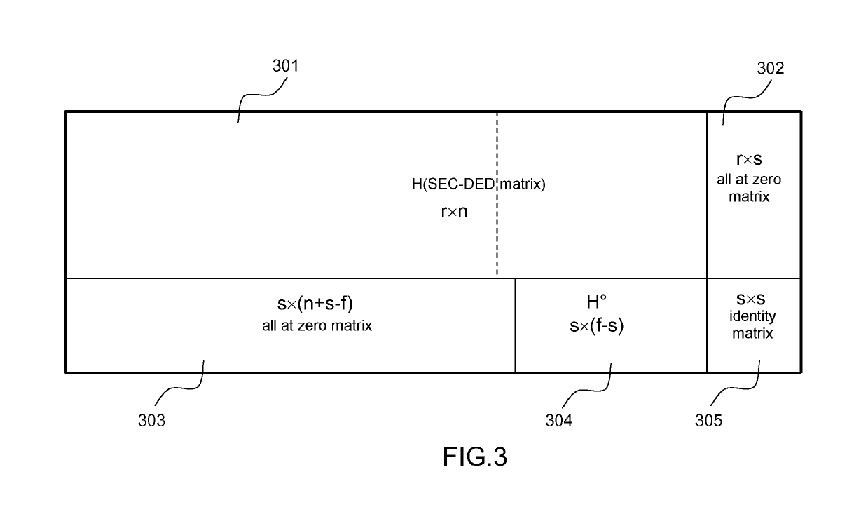

FIG. 3 presents one example of structure of a parity-check matrix H allowing the implementation of an asymmetric A-EDAC code providing the correction of single errors over the whole of the code words, the correction of double errors affecting a sub-set of bits in the code words and the detection of uncorrectable double errors over the whole of said word;

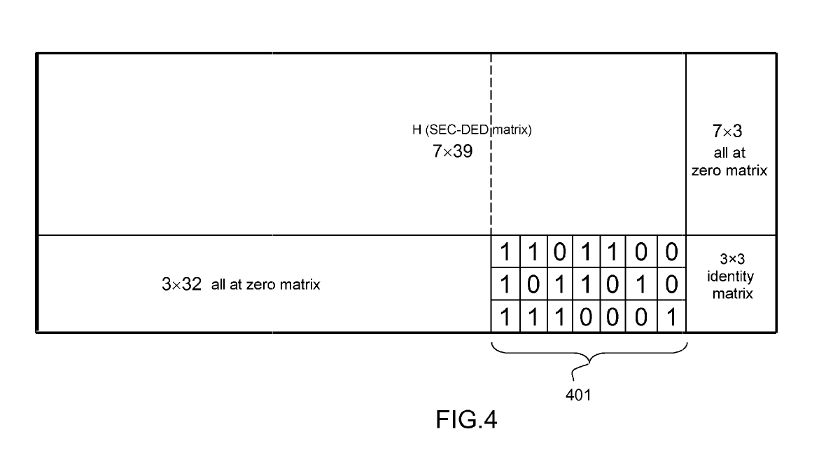

FIG. 4 shows one specific example of a parity-check matrix H according to the generic matrix H described with the aid of FIG. 3;

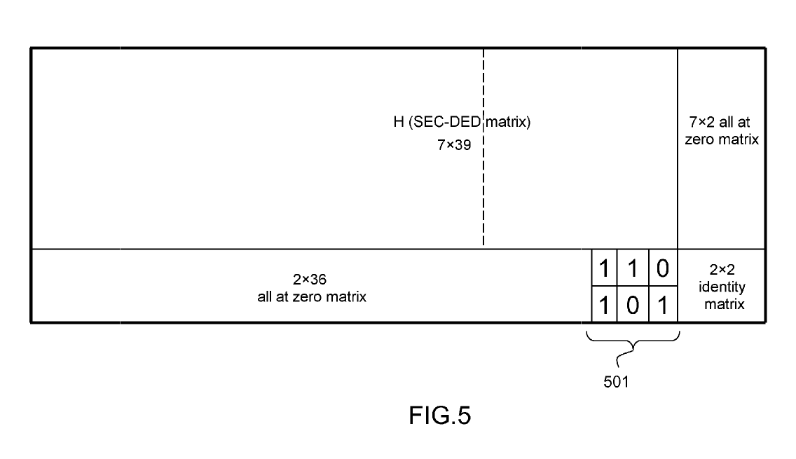

FIG. 5 shows a second specific example of a parity-check matrix H according to the generic matrix H described with the aid of FIG. 3;

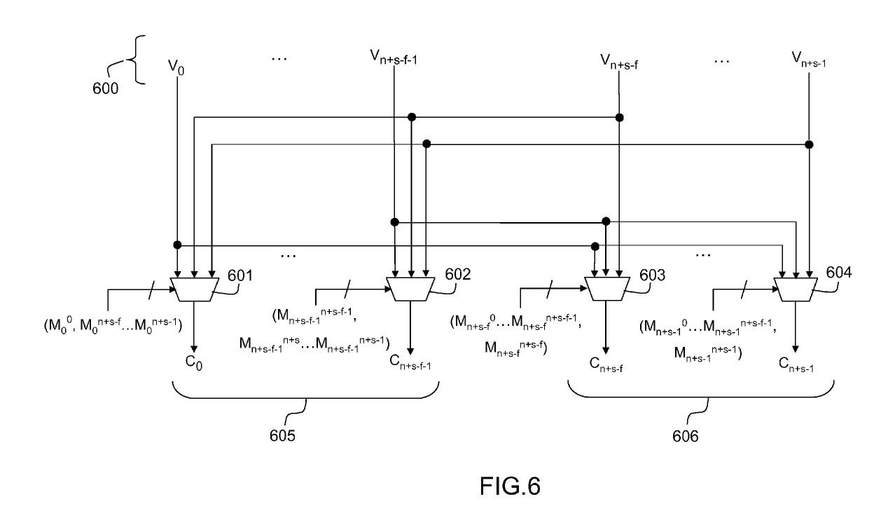

FIG. 6 presents one example of a swapping module according to the invention.

FIG. 1 illustrates the principle of a memory protection device according to the invention. The device 100 contains for example two modules performing separate operations implementing the protection according to the invention, whether this be for read or write access to a memory.

During a write access, the first module 101 performs the function of encoding the data presented in the form of words using, for example, an asymmetric code. In the following part of the description, an asymmetric code denotes an EDAC code associating different levels of protection with several sub-groups of bits composing the code words. This type of code is also denoted in the description using the acronym A-EDAC.

In the following part of the description, the examples of asymmetric A-EDAC codes chosen exhibit two levels of protection: a code word comprises a first sub-set of bits associated with a high level of protection and a second sub-set of bits associated with a low level of protection.

The choice of the A-EDAC code depends on the application and on the type of protection sought.

By way of example, in the case where it is desired to protect the digital memory only against the permanent errors, a limited SEC code may be chosen. The latter is classed as limited in the sense that the low levels of protection correspond to the absence of protection. In this example, a code word can be divided into two subsets of bits with which the aforementioned two levels of protection are associated. The limited SEC code provides a correction of single errors affecting the first sub-set of bits of the code word, the second group of bits not being protected.

Another example corresponds to the case where a protection of the memory is sought against both permanent errors and against transient errors. In this case, an appropriate A-EDAC code is for example an extended SEC-DED code introducing two levels of protection associated with two subsets of the code word. As already mentioned, the first level of protection is said to be high and the second level of protection is said to be low. This code is designed so as to allow for a given code word:
the correction of a single error over the whole of the code word;
the correction of a double error affecting the sub-set of bits with a high level of protection;
the detection of any double error over the whole of the code word which does not affect any bit of the sub-set of bits with a high level of protection.

The cardinality of the sub-set of bits of the code word whose level of protection is high depends on the number s of replacement columns in the storage area.

A second module 102 has the function of establishing a connection between the bits of the encoded data produced by the module 101 carrying out the encoding and the memory columns constituting the storage area 104. This module makes the best protected bits of the code words correspond to the columns of the storage area possessing defective memory cells. These bits are thus routed toward said columns during the write operation. This correspondence is provided by the second module 102 called a bit-swapper module. This module 102 notably uses as input data configuration information 103 coming from tests on the storage area 104. These tests are carried out prior to the use of the memory, or else during operations for maintenance of the circuit, and indicate for each storage area used which are the columns comprising defective memory cells.

In the case where the device is used during a read access, the bits of each memory column go via the bit-swapper 102 so as to recover their original position in the A-EDAC code word. The code word is then checked by the module 101 carrying out the decoding of the A-EDAC code. Said module performs the error detection and correction operations and allows the word of corrected data or else an error signal indicating the presence of an uncorrectable error to be obtained at the output.

FIG. 2 presents one example of a parity-check matrix H allowing the implementation of an asymmetric A-EDAC code providing the correction of single errors affecting a sub-set off bits in the code words.

For this purpose, the matrix H is arranged in such a manner as to introduce two levels of protection in one code word. Two subsets of bits composing a code word are associated with the two levels of protection. The first sub-set of bits is composed of f=2^{s}−1 bits of a code word and is protected in such a manner as to allow the correction of a single error. s denotes the number of check bits, this corresponding to the number of replacement columns available in the storage area. The number of rows in the matrix H is equal to s. The number of columns in the matrix H is equal to the number of memory columns said to be regular k where the data bits are stored to which are added the number s of replacement columns with f<k+s. All the elements of the matrix H belong to the set {0,1}. The matrix H is composed of three sub-matrices. The first sub-matrix 201 possesses k+s−f columns and all its elements are equal to 0. The second sub-matrix 202 possesses f−s columns, said columns being defined in that they:
comprise at least one non-zero element;
are different from the columns of the third matrix 203 described hereinafter;
are different from one another.

The third sub-matrix 203 is an s×s identity matrix, in other words comprising s rows and s columns. The sub-matrices 202 and 203 form an s×f Hamming matrix, in other words with s rows and f columns and where all the columns are different from one another and different from the null vector.

The parity-check matrix H in FIG. 2 allows a coding to be implemented introducing a protection of the sub-set of bits composed of the last f bits of each code word, a code word comprising k>f−s data bits and s check bits. Amongst these f bits, there are f−s data bits and s check bits. The encoding and the verification of these f−s data bits are identical to a Hamming code with s check bits and f−s data bits. The f bits correspond to the sub-set of bits with which the high level of protection is associated.

FIG. 3 presents one example of a generic structure of a parity-check matrix H allowing the implementation of an asymmetric A-EDAC code obtained by the extension of an SEC-DED code with s additional check bits, with the aim of:
allowing the correction of a single error over the whole of the code word;
providing the correction of any given double error which affects at least one bit of a sub-set of f bits in the code word, this sub-set being that with which a high level of protection is associated;
allowing the detection of any given double error which does not satisfy the preceding condition.

The matrix H is obtained by extension starting from a first sub-matrix 301 representing the parity-check matrix of a standard SEC-DED code with k data bits and r check bits. The sub-matrix 301 possesses r rows and n=k+r columns. The last r columns in the sub-matrix 301 correspond to the check bits. Since the A-EDAC code comprises s additional check bits with respect to the SEC-DED code of the sub-matrix 301, the matrix H must have s additional columns and s additional rows with respect to the sub-matrix 301.

The extension of the sub-matrix 301 is carried out with the aid of four other sub-matrices:
one sub-matrix 302 comprising r rows and s columns situated on the right of the sub-matrix 301;
one sub-matrix 303 with s rows and n+s−f columns situated underneath the sub-matrix 301;
one sub-matrix 304 comprising s rows and f−s columns and situated underneath the sub-matrix 301 and on the right of the sub-matrix 303;
one sub-matrix 305 comprising s rows and s columns and situated underneath the sub-matrix 302 and on the right of the sub-matrix 304.

The sub-matrices 302 and 303 are null matrices, in other words they have all their elements positioned at zero.

The sub-matrix 305 is an s×s identity matrix.

The sub-matrix 304 must have all its columns different from one another and comprise at least one non-zero element. This results in a maximum number of 2^{s}−1 columns for the sub-matrix 304. The parameter f is then equal to 2^{s}−1+s.

In order to allow the implementation of fast A-EDAC decoders, the sum f of the columns of the sub-matrices 304 and 305 can be chosen so as to be less than or equal to r+s. The parameter f is therefore the smaller of the two numbers r+s and 2^{s}−1+s. Thus, the number of columns in the sub-matrix 304 is limited by the number r of check bits of the SEC-DED code represented by the matrix 301.

The columns of the sub-matrices 304 and 305 correspond to a sub-set of f check bits of the A-EDAC code. As previously indicated, all the double errors which affect these f check bits must be able to be corrected. In order to achieve this objective, the choice of the sub-matrix 304 imposes a constraint on the sub-matrix 301. In order to explain this constraint, the combination of a certain number of columns in a (sub-)matrix is firstly defined as a vector of which each bit:
corresponds to one row in the (sub-)matrix in question and;
is the result of an exclusive OR between the bits corresponding to the same row in the combined columns.

Xs denotes the set of the triplets of columns in the sub-matrix 304 whose combination yields a vector with all the bits positioned at zero. The columns of each triplet of Xs extended over the whole matrix H define as many triplets in the sub-matrix 301. If the set formed by the latter triplets is denoted by Xr, the constraint on the sub-matrix 301 prohibits the presence in this sub-matrix of a column identical to the combination of the columns in each triplet of the set Xr. By virtue of the constraint f<r+s, all the columns in the triplets of Xr correspond to the check bits of the SEC-DED code represented by the sub-matrix 301.

The manner of generating the r+s check bits for this example of A-EDAC code is described by the matrix H and can be implemented as for any other linear code. More precisely, by virtue of the form of the matrix H, the first r check bits are identical to the check bits of the SEC-DED code with the parity-check matrix identical to the sub-matrix 301. These check bits can, in turn, be used for the calculation of the other s check bits with the aid of the sub-matrices 304 and 305.

During the decoding of the words of the code, r+s bits of a syndrome vector Sj with 0≦j<r+s are calculated as in the case of any given linear code. The correction of the errors affecting the data bits V′i (0≦i<k) obtained in the storage area is carried out using, for example, the following expression:

Vᵢ=V′ᵢ⊕BitFlipᵢ 0≦i<k (1)

in which:
k is the number of data bits;
i is the index of a data bit with 0≦i<k;
the symbol ‘⊕’ represents the exclusive OR logical operation;
Vᵢ represents the i^{th} corrected data bit;
BitFlipᵢ is a signal calculated using the following expression:

$${BitFlip}_{i} = {{⋀}_{j = 0}}^{r + s - 1} ( {H}_{j}^{i} \overline{⊕} {S}_{j} ) ⋁ {{⋁}_{l = n + s - f}}^{n + s - 1} [ {{⋀}_{j = 0}}^{r + s - 1} ( {H}_{j}^{i} ⊕ {H}_{j}^{l} ) \overline{⊕} {S}_{j} ] ; \\ 0 \leq i < k \qquad ( 2 )$$

in which:
r is the number of check bits of the SEC-DED code represented by the sub-matrix 301;
n is the total number of bits in the SEC-DED code, represented by the sub-matrix 301;
s is the number of additional check bits in the A-EDAC code;
f is the number of the last check bits of the A-EDAC code for which the correction is provided of all the double errors in which these bits are involved;
the symbol ‘ δ̅’ represents the inverse exclusive OR logical operation;
the symbol ‘ [symbol] ’ represents the AND logical operation;
the symbol ‘ [symbol] ’ represents the OR logical operation, and
Hⱼⁱ represents the element situated on the i^{th} row and the i^{th} column in the parity-check matrix H.

The chosen form for the parity-check matrix H of the A-EDAC code allows a fast detection of the uncorrectable double errors by means of the following expression, where all the symbols and notations have been defined beforehand:

$${{⋁}_{j = 0}}^{r - 1} {S}_{j} ⋀ \overline{{{⊕}_{i = 0}}^{n - 1} {V}_{i}^{′}} ⋀ \overline{{{⋁}_{j = r}}^{r + s - 1} {S}_{j}} \qquad ( 3 )$$

Subsequently, the sub-matrix 304 of the A-EDAC codes obtained by the extension of the SEC-DED codes will be denoted with the symbol H°.

FIG. 4 shows one specific example of a parity-check matrix H according to the generic matrix H described with the aid of FIG. 3. This is a parity-check matrix H of an A-EDAC code which is obtained by extension with 3 additional check bits added to a SEC-DED code with 32 data bits. It comprises a sub-matrix H° 401 with 3 rows and 2³−1=7 columns. The number of columns in the matrix H° is equal to the number of check bits in the SEC-DED code. The words of the SEC-DED code comprise 32 data bits and 7 check bits. The A-EDAC code resulting from this allows any given double error affecting the f=10 check bits of a word of the code to be corrected. In this case, the parameter f is equal to the total number of check bits in the code r+s but also to the expression 2^{s}−1+s.

FIG. 5 shows one specific example of a parity-check matrix H according to the generic matrix H described with the aid of FIG. 3.

This example allows an A-EDAC code corresponding to the extension of a SEC-DED code with 2 additional check bits to be obtained. The SEC-DED code words have 32 data bits and 7 check bits. The sub-matrix H° 501 comprises 2²−1=3 columns. The code resulting from this matrix allows the correction of all the double errors which affect the last f=2²−1+2=5 check bits in the code words.

FIG. 6 presents one example of a bit-swapper module. The device establishes a connection between the bits of the code words generated by an asymmetric code and the columns of the storage area by taking into account the presence of the defective storage cells in the columns of said area.

A connection is established between each bit Vⱼ of a code word 600 and each memory column Cᵢ. The indices i and j are such that 0≦j<n+s and 0≦i<n+s.

The implementation of these connections is established by means of multiplexers 601, 602, 603, 604 controlled by control signals Mᵢ^{j}. The output of a given multiplexer is connected to a given column of the storage area.

The first n+s−f multiplexers 605 receive at their input the last f bits Vⱼ (n+s−f≦j<n+s) of a word of the code, in other words the bits with which a high level of protection is associated. Thus, one of these f inputs is routed toward the column of the storage area associated with the multiplexer if said column contains defective storage cells.

The connection between the positions in the words of the A-EDAC code and the memory columns can be made by cross-swapping. By way of example, if the j^{th} bit of the code word is connected to the i^{th} column of the storage area, then the i^{th} bit of the code word is connected to the j^{th} column of the storage area. In order to allow these cross-swapping processes, the last f multiplexers receive the first n+s−f bits of the code words at their inputs. If the first n+s−f columns of the storage area have all their storage cells operational, in other words non-defective, then the corresponding multiplexers will be configured in such a manner as to select at the input the bit in the code words having the same index as the column connected to the output of said multiplexer.

The control signals can be generated as a function of bits Tᵢ with 0≦i<n+s−f, indicating whether the first n+s−f memory columns have defective storage cells, and also of bits T′ⱼ indicating whether the j^{th} column of the storage area with n+s−f≦j<n+s is used for storing bits of index j in the words of the code. The signals Mᵢ^{j}, with 0≦i<n+s−f, controlling the first n+s−f multiplexers 605 are generated based on bits Tᵢ, and T′ⱼ. For this purpose, the following expressions, where all the symbols and notations have been previously defined, may be used:

$$\begin{matrix}{M}_{i}^{i} = {\overline{T}}_{i} ; & ( 4 ) \\ {M}_{i}^{j} = {T}_{i} ⋀ \overline{{T}_{j}^{i}} ⋀ ( \overline{{{⋁}_{t = n + s - f}}^{j - 1} {M}_{i}^{t}} ) ⋀ ( \overline{{{⋁}_{s = 0}}^{i - 1} {M}_{s}^{j}} ) ; & ( 5 ) \\ 0 \leq i < n + s - f ; n + s - f \leq j < n + s & ( 6 )\end{matrix}$$

The control signals Mᵢ^{j} for the last f multiplexers 606, with n+s−f≦i<n+s and 0≦j<n+s−f, may be generated using the following expressions:

Mᵢⁱ=T′ᵢ; (7)

Mᵢ^{j}=Mⱼⁱ; (8)

n+s−f≦i<n+s; 0≦j<n+s−f (9)

A memory circuit can be segmented into several storage areas, also referred to as memory banks or segments. The invention may be advantageously applied to the memory banks which do not contain more than one defective storage cell in the same code word. Conventional methods, such as for example column masking, can be used for the memory segments or banks which have at least two defective storage cells in the same code word. This situation usually occurs in memory banks or segments which have columns that are entirely damaged.

The matrices shown are only examples; permutations of the columns of the matrix could be applied.

An extended SEC may be implemented without it being DED. The sub-matrix 301 then represents a SEC code and not a SEC-DED code.

1. A method for protecting digital data stored in at least one storage area, said area corresponding to a storage matrix composed of memory cells organized in a given number of rows and columns, said method comprising:
an encoding step generating code words from data organized in binary words by application of an asymmetric code introducing at least two different levels of protection, the first level of protection said to be high being associated with a first sub-group of bits of the code word and a second level of protection said to be low being associated with a second sub-group of the same word; and
a step for swapping positions of the bits of the code word making the bits with a high level of protection correspond for their storage to the columns of the storage area comprising defective memory cells and the bits with a low level of protection to the remaining columns.

2. The method as claimed in claim 1 wherein the number of bits of a code word correspond to the numbers of columns available in a storage area.

3. The method as claimed in claim 1 wherein the asymmetric code is chosen in such a manner as to introduce a protection on the last f bits of each code word by using a Hamming code, the sub-group composed of the other bits of said word not being protected.

4. The method as claimed in claim 1 wherein the asymmetric code is an extended SEC-DED code with s additional check bits.

5. The method as claimed in claim 4 wherein the matrix of the asymmetric code is designed in such a manner that said code allows the correction of a single error over the whole of the code word, provides the correction of any given double error which affects at least one bit of a sub-set of f bits in the code word, this sub-set being that with which a high level of protection is associated, and allows the detection of the other double errors over the whole of the word of the code.

6. A method for reading digital data stored in a storage area and protected by implementation of the method as claimed in claim 1, further comprising:
a step for the re-ordering of the bits of the stored code words in such a manner that the latter recover their initial order from before the position swap carried out when they are written into memory; and
a step for decoding said re-ordered code words, this step carrying out a detection of errors in the code word together with an error correction, said detection and correction depending on the asymmetric code used in the encoding and also on its capacities for correction and for detection.

7. A device for protection of digital data stored in at least one storage area, said area corresponding to a storage matrix composed of memory cells organized in a given number of rows and columns, said device further comprising at least:
one encoding module generating code words from data organized in binary words by application of an asymmetric code introducing at least two different levels of protection, the first level of protection said to be high being associated with a first sub-group of bits of the code word and the second level of protection said to be low being associated with a second sub-group of the same word; and
one module for swapping position of the bits of the code word making the bits with a high level of protection of said words correspond for their storage to the columns of the storage area comprising defective memory cells and the bits with a low level of protection to the remaining columns.

8. The device as claimed in claim 7 wherein the position swap of the bits carried out by the swapping module is controlled by using configuration data indicating the memory columns comprising defective memory cells of the storage area.

9. The device as claimed in claim 7 wherein the swapping module comprises multiplexers allowing the bits to be routed at the output of the encoding module toward the columns of the storage area, said multiplexer being controlled by control signals Mᵢ^{j} representative of the configuration data.

10. The device as claimed in claim 8 further comprising means for re-ordering the bits of the stored code words in such a manner that the latter recover their initial order from before the swap, and means for decoding the re-ordered code words while carrying out a detection of errors in the code word together with a correction of errors, said detection and correction depending on the asymmetric code used by the encoding module and also on its capacity for correction and for detection.

11. The device as claimed in claim 10 wherein an uncorrectable error is detected, and an error signal is generated.
